(19) United States
(12) Patent Application Publication
(10) Pub. No.: US 2026/0197795 A1
(43) Pub. Date: Jul. 9, 2026

(54) METHOD FOR POSITIONING, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Hao LIN, Dongguan (CN)

(21) Appl. No.: 19/555,210

(22) Filed: Mar. 3, 2026

Related U.S. Application Data
(63) Continuation of application No. PCT/CN2023/131635, filed on Nov. 14, 2023.

(51) Int. Cl. H04W 64/00; G01S 19/39; H04L 5/00

(52) U.S. Cl. CPC H04W 64/00; G01S 19/39; H04L 5/0044

(57) ABSTRACT

A method for positioning, a terminal device, and a network device are provided. The method includes: a terminal device sends first information to a network device, the first information is associated with the validity of first position information, the first position information is determined based on a first positioning mode, and the first positioning mode is a satellite-based positioning mode.

### CROSS-REFERENCE TO RELATED APPLICATION

This application is a continuation of International Application No. PCT/CN2023/131635 filed on November 14, 2023, the disclosure of which is hereby incorporated by reference in its entirety.

### BACKGROUND

In a satellite communication system, a terminal device needs to determine its own location information based on a satellite. After determining the location information of the terminal device, the terminal device may evaluate the bi-directional transmission delay of the serving link between the satellite and the terminal device, and pre-compensate for the transmission delay for each uplink transmission. By pre-compensating the transmission delay, the satellite communication system may maintain the synchronization between terminal devices. However, if the satellite signal deteriorates or the terminal device cannot receive the satellite signal, there is currently no suitable solution for how the terminal device should deal with it.

### SUMMARY

The present disclosure relates to the technical field of communication, and provides a method for positioning, a terminal device, and a network device. Various aspects of the present disclosure will be described in detail below.

According to a first aspect, there is provided a method for positioning, including that a terminal device transmits first information to a network device. The first information is associated with a validity of first location information, the first location information is determined based on a first positioning mode, and the first positioning mode is a satellite-based positioning mode.

In a second aspect, there is provided a terminal device including a memory for storing a program and a processor for calling the program in the memory to cause the terminal device to perform the method of the first aspect.

In a third aspect, there is provided a network device including a memory for storing a program and a processor for invoking the program in the memory to cause the network device to receive first information transmitted by a terminal device, the first information is associated with validity of first location information, the first location information is determined based on a first positioning mode, and the first positioning mode is a satellite-based positioning mode.

### BRIEF DESCRIPTION OF THE DRAWINGS

FIG. 1A is an example diagram of a communication scenario to which an embodiment of the present disclosure can be applied.

FIG. 1B is an example diagram of another communication scenario to which an embodiment of the present disclosure can be applied.

FIG. 1C is an example diagram of yet another communication scenario to which an embodiment of the present disclosure can be applied.

FIG. 2 is an exemplary diagram of another communication scenario to which an embodiment of the present disclosure can be applied.

FIG. 3 is an exemplary diagram of another communication scenario to which the embodiment of the present disclosure can be applied.

FIG. 4 is an exemplary diagram of another communication scenario to which the embodiment of the present disclosure can be applied.

FIG. 5 is a schematic flow diagram of a method for positioning according to an embodiment of the present disclosure.

FIG. 6 is a schematic flow diagram of a method for positioning according to another embodiment of the present disclosure.

FIG. 7 is a schematic structural diagram of a terminal device according to an embodiment of the present disclosure.

FIG. 8 is a schematic structural diagram of a terminal device according to another embodiment of the present disclosure.

FIG. 9 is a schematic structural diagram of a network device according to an embodiment of the present disclosure.

FIG. 10 is a schematic structural diagram of a network device according to another embodiment of the present disclosure.

FIG. 11 is a schematic structural diagram of a device to which an embodiment of the present disclosure can be applied.

### DETAILED DESCRIPTION

Communication system architecture

The technical solution of the embodiment of the present disclosure can be applied to various communication systems, such as global system of mobile communication (GSM) systems, code division multiple access (CDMA) system, wideband code division multiple access (WCDMA) system, general packet radio service (GPRS), long term evolution (LTE) system, advanced long term evolution (LTE-A) system, new radio (NR) system, evolution of NR system, LTE-based access to unlicensed spectrum (LTE-U) system on unlicensed spectrum, NR-based access to unlicensed spectrum (NR-U) on unlicensed spectrum system, non-terrestrial network (NTN) system, universal mobile telecommunication system (UMTS), wireless local area networks (WLAN), wireless fidelity (Wi-Fi), 5th-generation (5G) systems or other communication systems (such as future communication systems like the sixth-generation (6G) mobile communication systems, as well as satellite communication systems, etc.).

Generally speaking, conventional communication systems support a limited number of connections and are easy to implement. However, with the development of communication technology, the mobile communication system will support not only conventional communication, but also, for example, device-to-device (D2D) communication, machine-to-machine (M2M) communication, machine type communication (MTC), vehicle-to-vehicle (V2V) communication, or vehicle-to-everything (V2X) communication, and the like, and the embodiment of the present disclosure may also be applied to these communication systems.

The communication system in the embodiment of the present disclosure may be applied to a carrier aggregation (CA) scenario, a dual connectivity (DC) scenario, or a standalone (SA) network layout scenario.

The communication system in the embodiment of the present disclosure can be applied to an unlicensed spectrum, and the unlicensed spectrum may also be regarded as a shared spectrum. Alternatively, the communication system in the embodiment of the present disclosure may also be applied to a licensed spectrum, and the licensed spectrum may also be regarded as a dedicated spectrum.

The embodiments of the present disclosure may be applied to an NTN system or a terrestrial networks (TN) system. By way of example and not limitation, NTN systems include NR-based NTN systems and internet of things (IoT)-based NTN systems.

Embodiments of the present disclosure describe various embodiments in connection with a network device and a terminal device, where the terminal device may also be referred to as a user equipment (UE), an access terminal, a subscriber unit, a subscriber station, a mobile site, a mobile station (MS), a mobile Terminal (MT), a remote station, a remote terminal, a mobile device, a user terminal, a terminal, a wireless communication device, a user agent or a user device, and the like.

In an embodiment of the present disclosure, the terminal device may be a STATION (ST) in the WLAN, a cellular telephone, a cordless telephone, a session initiation protocol (SIP) telephone, a wireless local loop (WLL) station, a personal digital assistant (PDA) device, a handheld device having a wireless communication function, a computing device or other processing device connected to a wireless modem, a vehicle-mounted device, a wearable device, a terminal device in a next generation communication system (such as an NR network), or a future evolved public land mobile network (PLMN) network.

In an embodiment of the present disclosure, the terminal device may be a device that provides voice and/or data connectivity to a user, and may be used to connect people, objects, and machines, for example, a handheld device having a wireless connection function, a vehicle-mounted device, or the like. The terminal device in the embodiment of the present disclosure may be a mobile phone, a tablet (Pad), a notebook computer, a handheld computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. Alternatively, the terminal device may be used to act as a base station. For example, the terminal device may act as a scheduling entity that provides sidelink signals between the terminal devices in V2X or D2D, etc. For example, cellular telephones and automobiles communicate with each other using sidelink signals. Communication between cellular phones and smart home devices without relaying communication signals through base stations.

In an embodiment of the present disclosure, the terminal device may be deployed on land, including indoor or outdoor, handheld, wearable, or vehicle-mounted. It may also be deployed on the water (such as ships, etc.). It may also be deployed in the air (e.g. on aircraft, balloons and satellites, etc.).

In an embodiment of the present disclosure, the terminal device may be a mobile phone, a tablet computer, a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, or the like. The terminal device according to the embodiment of the present disclosure may also be referred to as a terminal, a user equipment (UE), an access terminal device, a vehicle-mounted terminal, an industrial control terminal, a UE unit, a UE station, a mobile station, a mobile site, a remote station, a remote terminal device, a mobile device, a UE, a wireless communication device, a UE agent, a UE apparatus, or the like. The terminal device may also be stationary or mobile.

As an example and not limitation, in an embodiment of the present disclosure, the terminal device may also be a wearable device. Wearable devices may also be called wearable smart devices, which are a general term of devices for applying wearable technology to intelligently design daily wear and develop wearable devices, such as glasses, gloves, watches, clothing and shoes. A wearable device is a portable device that is worn directly on the body or integrated into the user's clothes or accessories. Wearable devices are not only hardware devices, but also realize powerful functions through software support, data interaction and cloud interaction. Generalized wearable smart devices include full functions, large size, and can realize complete or partial functions without relying on smart phones, such as smart watches or smart glasses, as well as those that only focus on a certain type of application functions and need to be used in conjunction with other devices such as smart phones, such as various smart bracelets and smart jewelry for physical sign monitoring.

The network device in the embodiment of the present disclosure may be a device for communicating with a terminal device, and the network device may also be referred to as an access network device or a radio access network device. For example, the network device may be a base station. The network device in the embodiment of the present disclosure may refer to a radio access network (RAN) node (or device) that connects the terminal device to the wireless network. The base station may generally cover or be substituted for various names such as a NodeB, an evolved NodeB, a next generation base station, a relay station, an access point, a transmitting and receiving point (TRP), a transmitting point (TP), a master station (MeNB), a secondary station (SeNB), a Multi-Standard Radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a location node, and the like. The base station may be a macro base station, a micro base station, a relay node, a donor node, or the like, or a combination thereof. The base station may also refer to a communication module, modem, or chip for disposal within the aforementioned device or apparatus. The base station may also be a mobile switching center, a device that assumes a base station function in device-to-device (D2D), a vehicle-to-everything (V2X), a machine-to-machine (M2M) communication, a network-side device in a 6G network, a device that assumes a base station function in a future communication system, or the like. The base stations may support networks of the same or different access technologies. The embodiments of the present disclosure do not limit the specific technology and the specific device form adopted by the network device.

The base station may be fixed or mobile. For example, a helicopter or drone may be configured to act as a mobile base station, and one or more cells may move based on the location of the mobile base station. In another example, a helicopter or drone may be configured as a device communicating with another base station.

In some deployments, the network device in the embodiment of the present disclosure may refer to a CU or a DU, or the network device includes a CU and a DU. The gNB may also include an AAU.

Network devices and terminal devices may be deployed on land, including indoor or outdoor, handheld or vehicle-mounted. It may also be deployed on the water. It may also be deployed on aircraft, balloons and satellites in the air. In the embodiment of the present disclosure, the scenario in which the network device and the terminal device are located is not limited.

By way of example and not limitation, in embodiments of the present disclosure, the network device may have mobile characteristics. For example, the network device may be a mobile device. In some embodiments of the present disclosure, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments of the present disclosure, the network device may also be a base station disposed on land, water, or the like.

In an embodiment of the present disclosure, the network device may provide a service for a cell, and the terminal device communicates with the network device through a transmission resource (for example, frequency domain resource or spectrum resource) used by the cell. The cell may be a cell corresponding to the network device (for example, a base station), and the cell may belong to a macro base station or a base station corresponding to a small cell. Here, the small cell may include a metro cell, a micro cell, a pico cell, a femto cell, and the like. These small cells are characterized by small coverage range and low transmission power, and are suitable for providing high-rate data transmission services.

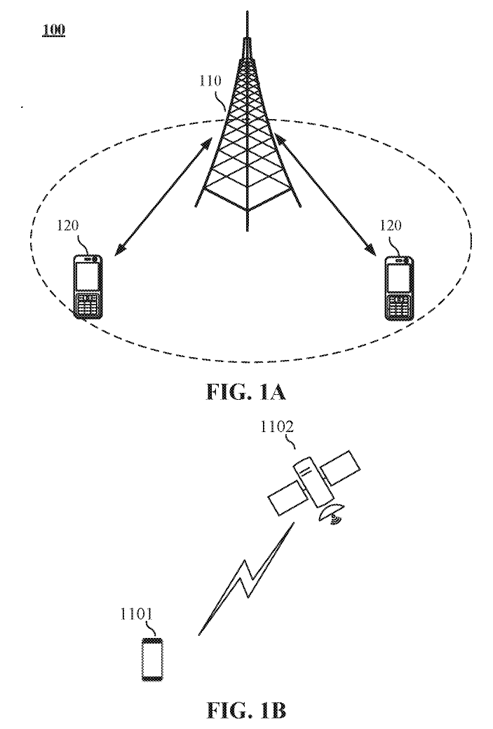

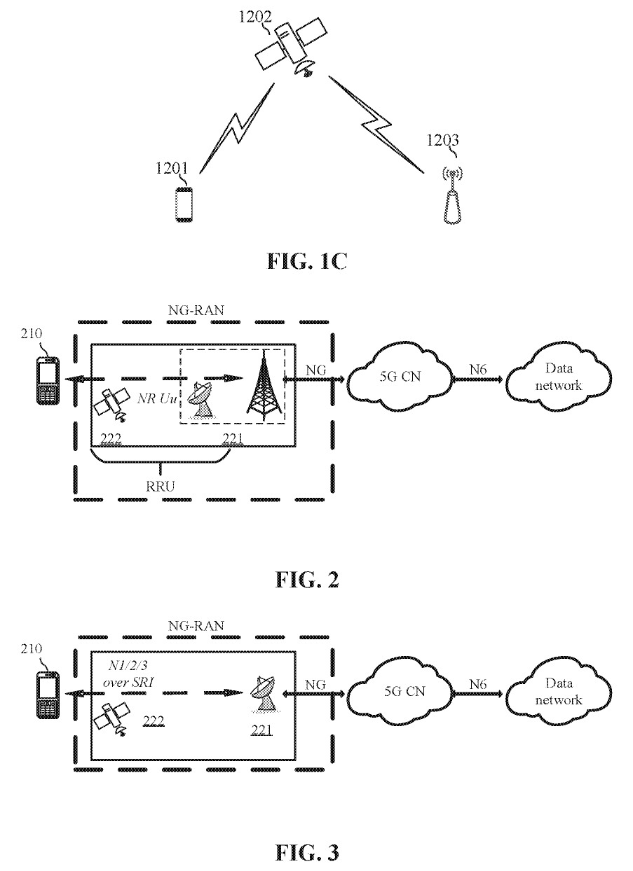

Exemplarily, FIG. 1A is an architectural diagram of a communication system according to an embodiment of the present disclosure. As illustrated in FIG. 1A, the communication system 100 may include a network device 110, which may be a device that communicates with a terminal device 120 (or referred to as a communication terminal, a terminal). The network device 110 may provide communication coverage for a particular geographic area and may communicate with terminal devices located within the coverage area.

FIG. 1A exemplarily illustrates one network device and two terminal devices. In some embodiments of the present disclosure, the communication system 100 may include multiple network devices and the coverage range of each network device may include another number of terminal devices, which is not limited by the embodiments of the present disclosure.

FIG. 1B is an architectural diagram of another communication system according to an embodiment of the present disclosure. Referring to FIG. 1B, a terminal device 1101 and a satellite 1102 are included, and wireless communication may be performed between the terminal device 1101 and the satellite 1102. The network formed between the terminal device 1101 and the satellite 1102 may also be referred to as an NTN. In the architecture of the communication system illustrated in FIG. 1B, the satellite 1102 may have the function of a base station, and the terminal device 1101 and the satellite 1102 may communicate directly. Under the system architecture, the satellite 1102 may be referred to as a network device. In some embodiments of the present disclosure, the communication system may include multiple network devices 1102, and the coverage range of each network device 1102 may include another number of terminal devices, which is not limited by the embodiments of the present disclosure.

Exemplarily, FIG. 1C is an architectural diagram of another communication system according to an embodiment of the present disclosure. Referring to FIG. 1C, there are a terminal device 1201, a satellite 1202, and a base station 1203, wireless communication may be performed between the terminal device 1201 and the satellite 1202, and communication may be performed between the satellite 1202 and the base station 1203. The network, formed between the terminal device 1201, the satellite 1202 and the base station 1203, may also be referred to as an NTN. In the architecture of the communication system illustrated in FIG. 1C, the satellite 1202 may not have the function of a base station, and communication between the terminal device 1201 and the base station 1203 needs to be relayed through the satellite 1202. Under this system architecture, the base station 1203 may be referred to as a network device. In some embodiments of the present disclosure, the communication system may include multiple network devices 1203, and the coverage range of each network device 1203 may include another number of terminal devices, which is not limited in the embodiments of the present disclosure.

It should be noted that FIGS. 1A to 1C only illustrate systems to which the present disclosure is applicable in the form of examples, and of course, the method illustrated in the embodiment of the present disclosure may also be applied to other systems, such as a 5G communication system, an LTE communication system, and the like, which are not limited in the embodiments of the present disclosure.

In some embodiments of the present disclosure, the wireless communication system illustrated in FIGS. 1A to 1C may further include other network entities such as a mobility management entity (MME), an access and mobility management function (AMF), and the like, which are not limited in the embodiments of the present disclosure.

It should be understood that a device having a communication function in the network/system in the embodiment of the present disclosure may be referred to as a communication device. Taking the communication system 100 illustrated in FIG. 1A as an example, the communication device may include a network device 110 and a terminal device 120 having a communication function, and the network device 110 and the terminal device 120 may be specific devices described above, and will not be repeated here. The communication device may also include other devices in the communication system 100, such as other network entities such as a network controller and a mobility management entity, which are not limited in the embodiments of the present disclosure.

It should be understood that the "indication" mentioned in the embodiments of the present disclosure may be a direct indication, an indirect indication, or an associated relationship. For example, A indicates B, may mean that A directly indicates B, for example, B may be acquired by A; it may also mean that A indicates B indirectly, for example, A indicates C, and B may be obtained through C; it may also indicate that there is an association relationship between A and B.

In the description of the embodiments of the present disclosure, the term "correspondence" may indicate that there is a direct correspondence or indirect correspondence between the two, may indicate that there is a correlation between the two, or may indicate a relationship between indicating and being instructed, configuring and being configured, or the like.

The "configuration" in the embodiment of the present disclosure may include configuration by at least one of a system message, a radio resource control (RRC) signaling, and a media access control control element (MAC CE).

In some embodiments of the present disclosure, "predefined" or "preset" may be realized by storing corresponding codes, tables, or other methods that may be used to indicate relevant information in advance in devices (e.g., including terminal devices and network devices), and the present disclosure does not limit specific implementations thereof. For example, predefined may refer to what is defined in the protocol.

In some embodiments of the present disclosure, the "protocol" may refer to a standard protocol in the field of communication, and may include, for example, an LTE protocol, an NR protocol, and related protocols applied in future communication systems, which are not limited in the present disclosure.

At present, the 3rd generation partnership project (3GPP) is studying NTN technology. NTN generally uses satellite communication to provide communication services to ground users. Compared with terrestrial cellular communication, satellite communication has many unique advantages.

First of all, satellite communication is not restricted by the user's geographical area. For example, general terrestrial communication networks cannot cover areas such as oceans, mountains, and deserts where network equipment cannot be installed. Alternatively, the terrestrial communication network does not cover certain sparsely populated areas. For satellite communications, since a satellite can cover a large ground area and the satellite can orbit around the earth, theoretically, every corner of the earth can be covered by the satellite communication network.

Secondly, satellite communication has great social value. Satellite communication can cover remote mountainous areas, poor and backward countries or regions at a low cost, so that people in these areas can enjoy advanced voice communication and mobile Internet technology. From this perspective, satellite communication is conducive to narrowing the digital divide with developed regions and promoting the development of these regions.

Thirdly, satellite communication has the advantage of long distance, and the increase of communication distance does not significantly increase the cost of communication.

Finally, satellite communication has high stability and is not affected by natural disasters.

Communication satellites are divided into low earth orbit (LEO) satellites, medium earth orbit (MEO) satellites, geostationary earth orbit (GEO) satellites, high elliptical orbit (HEO) satellites, etc. based on different orbital altitudes. At present, LEO satellite and GEO satellite are mainly studied.

The LEO satellite generally has an altitude ranging from 500km to 1,500km. Accordingly, the orbital period of LEO satellite is about 1.5 hours to 2 hours. For the LEO satellite, the signal propagation delay of single-hop communication between users is generally less than 20ms. The maximum satellite visibility time of LEO satellite is about 20 minutes. LEO satellites have the advantages of short signal propagation distance, less link loss, and low transmission power requirements for users' terminal device.

The orbital altitude of the GEO satellite is 35,786 km. The GEO satellite rotates around the Earth for a period of 24 hours. For GEO satellites, the signal propagation delay of single-hop communication between users is generally about 250ms.

In order to ensure satellite coverage and improve the system capacity of the entire satellite communication system, satellites usually use multiple beams to cover the ground area. Therefore, a satellite can form dozens or even hundreds of beams to cover the ground area. A beam of a satellite can cover a ground area with a diameter of tens to hundreds of kilometers.

Currently, NTN systems include NR-NTN systems and internet of things (IoT)-NTN systems.

At present, there are two types of satellites considered by 3GPP, one is a transparent payload satellite, and the other is a regenerative payload satellite. The network architecture of satellites including transparent forwarding and the network architecture of satellites including regenerative forwarding are described below in conjunction with FIGS. 2 to 4, respectively.

In the satellite network architecture illustrated in FIGS. 2 to 4, the satellite network architecture may include a terminal device 210, a satellite node 222, and a ground receiving station 221 (referred to as a "ground station" for short). There is wireless communication between the terminal device 210 and the satellite node 222, and the terminal device 210 may transmit data to the satellite node 222 over a link between the terminal device 210 and the satellite node 222. For example, the data may be sent to the satellite node 222 over a service link. Accordingly, after the satellite node 222 receives the data, the satellite node 222 may transmit the data to the ground receiving station 221 through the link between the satellite node 222 and the ground receiving station 221. For example, the data may be communicated to the terrestrial receiving station 221 over a wireless link, such as a feeder link. Accordingly, after receiving the data of the satellite node 222, the ground receiving station 221 transmits the data to the core network (data network), and then processes the data through the core network, such as data interaction with other terminals. It can be understood that the service link herein refers to the link between the terminal device 210 and the satellite node 222, and the feeder link refers to the link between the satellite node 222 and the ground receiving station 221. In other possible embodiments, the link between the terminal device and the satellite node, and/or the link between the satellite node and the ground receiving station may also be represented by other terms, which are not limited in the present disclosure.

The types of satellite nodes 222 described above can be divided into three types, and the first type of satellite node is used only for forwarding, that is, only has a transparent forwarding function. In some implementations, such satellite nodes may provide only one or more of a radio frequency filtering function, a frequency conversion function, or a power amplification function. For this kind of satellite node, the received terminal device signal is amplified and then sent to the ground receiving station without any processing on the satellite node, as illustrated in FIG. 2. The terminal device and the satellite node may communicate with each other through the NR-Uu interface, and the satellite node and the ground receiving station (such as NTN Remote Radio Unit (RRU) and gNB) may communicate with each other through the NR-Uu interface, the ground receiving station and the 5G core network (5G CN) can communicate with each other through the N1/2/3 interface, and the 5G CN and the data network may communicate with each other through the N6 interface.

The second type of satellite node has complete base station processing functions. The satellite node is a base station for ground terminal device. The communication between the satellite node and the terminal device is substantially consistent with normal 5G communication, as illustrated in FIG. 3. In some implementations, such satellite nodes may also provide one or more of the following functions: a demodulation function, a decoding function, a routing function, a conversion function, an encoding function, or a modulation function. Among them, the terminal device and the satellite node may communicate with each other through an NR-Uu interface, and the satellite node and the ground receiving station may communicate with each other through a satellite radio interface (SRI), and the SRI interface may be used to send interface messages between the satellite node and the 5G CN (such as N2/N3 interface messages), the ground receiving station and the 5G CN may communicate with each other through an N1/2/3 interface, and the 5G CN and the data network may communicate with each other through an N6 interface.

The third type of satellite node has the processing function of DU. The satellite node is a DU for the ground terminal device. The communication between the satellite node and the terminal device is basically the same as the communication between the terminal device and the DU in the normal 5G terrestrial communication system, as illustrated in FIG. 4. The terminal device and the satellite node may communicate with each other through the NR-Uu interface, the satellite node and the ground receiving station (such as gNB-CU) may communicate with each other through the SRI interface, and the SRI interface may transmit F1 interface messages between the satellite and the ground receiving station, the ground receiving station and the 5G CN may communicate with each other through the N1/2/3 interface, and the 5G CN and the data network may communicate with each other through the N6 interface.

In satellite communication systems (such as NTN systems), the terminal device needs to support satellite-based positioning capabilities (e.g., the terminal device needs to be able to have global navigation satellite system (GNSS) capability) to determine the location of the terminal device. After determining the location information of the terminal device, the terminal device may estimate the bi-directional transmission delay of the serving link between the satellite and the terminal device and pre-compensate for the transmission delay for each uplink transmission. With the pre-compensation of the transmission delay, the satellite communication system is capable of maintaining the synchronization among terminal devices. However, in some situations (e.g. when the terminal device enters a tunnel, or the global positioning system (GPS) of the terminal device is unavailable), the satellite-based positioning accuracy of the terminal device becomes worse, or it may temporarily be unable to update its own location information based on the satellite. If the above situation is encountered, the location information of the terminal device may become inaccurate for a period of time. At this time, there is no suitable solution for how the terminal device should deal with it.

In view of the above problems, embodiments of the present disclosure will be described in detail below.

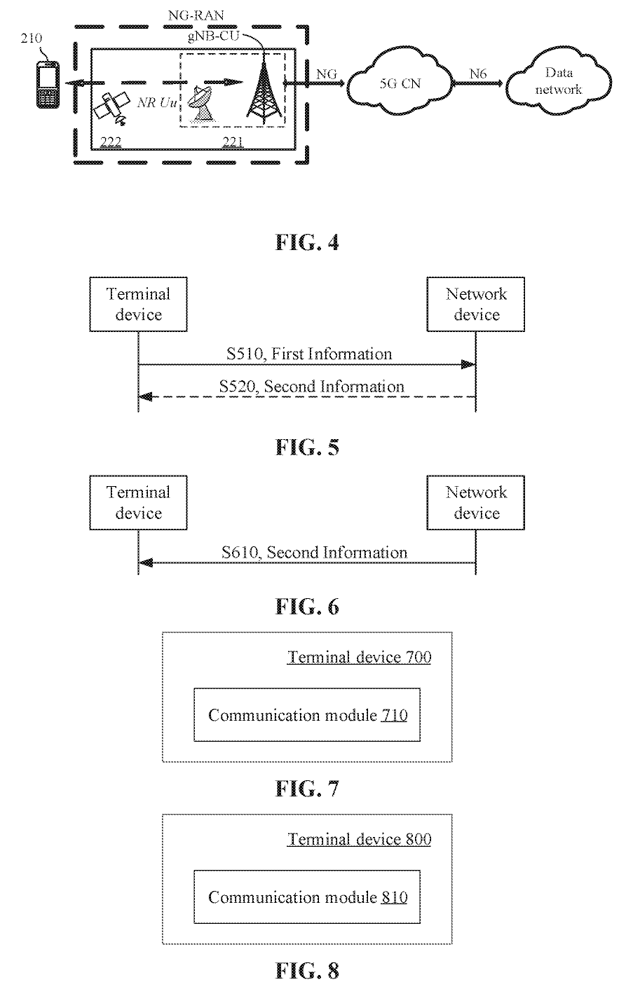

FIG. 5 is a schematic flow diagram of a method for positioning according to an embodiment of the present disclosure. The method of FIG. 5 is described from the perspective of interaction between the terminal device and the network device. The terminal device may be a terminal device in an NTN NR communication system. Alternatively, the terminal device may be a terminal device in an NTN IOT system. Alternatively, the terminal device may be any type of terminal device capable of supporting the positioning mode provided by the embodiment of the present disclosure.

Referring to FIG. 5, in operation S510, the terminal device transmits the first information to the network device. The first information may be carried in MAC CE, radio resource control (RRC), or uplink control information (UCI).

In some implementations, the first information is associated with a validity of the first location information. The first location information mentioned herein is determined based on the first positioning mode. The first positioning mode mentioned in the embodiment of the present disclosure refers to a satellite-based positioning mode. The satellite referred to herein may designate a bit navigation satellite. The positioning navigation satellite may include, for example, one or more of GPS satellites, GNSS satellites, Galileo satellites, or Beidou satellites.

In some implementations, the association of the first information with the validity of the first location information may include or be replaced by: the association of the first information with the measurement of the first positioning mode. For example, the first information is associated with a GNSS measurement.

In some implementations, the validity association of the first information with the first location information may include or be replaced with: the first information is used to indicate one or more of: a first period of time, the first period of time is a validity period of time of the first location information; the first location information is invalid or intends to be invalid; or, accuracy of the first location information does not satisfy a condition (or the accuracy of the first location information deteriorates).

In some implementations, the first information is transmitted in the event that the measurement based on the first positioning mode is unavailable, the accuracy thereof is deteriorated, the measurement based on the first positioning mode intends to be unavailable, or intends to deteriorate in accuracy.

In some implementations, the validity association of the first information and the first location information may include or be replaced by that: the first information is used to determine a remaining validity period of time of the location information of the terminal device (or location information determined based on the satellite positioning mode). That is, if the remaining valid period of time determined based on the first information expires, the location information of the terminal device (or the location information of the terminal device determined based on the satellite positioning mode) becomes invalid.

In an embodiment of the present disclosure, the terminal device transmits the first information to the network device. The first information is important to the network device and helps the network device to better schedule the terminal device. For example, based on the first information, the network device may accurately obtain the remaining valid time of the location information determined based on the satellite positioning, and then, after the remaining valid time ends, the network device may enable the terminal device to perform positioning by using another positioning mode to recover the location information of the terminal device. Alternatively, the network device may schedule the terminal device to suspend transmission of important information after the remaining valid time ends, thereby avoiding information loss.

In some implementations, the network device may enable the second positioning mode when the first location information of the terminal device becomes invalid or intends to be invalid, or when the terminal device cannot obtain satellite positioning data (such as GNSS data), or the satellite positioning data is unavailable. The second positioning mode is another positioning mode different from the first positioning mode. In other words, the second positioning mode is another positioning mode that is not based on satellites. The second positioning mode may be used to position the terminal device when the first location information is invalid (i.e., the location information determined based on the satellite is invalid). Since the network device may not be aware that the first location information of the terminal device is invalid or intends to be invalid, the second positioning mode may be requested by the terminal device. For example, the terminal device may request the network device to enable the second positioning mode based on the aforementioned first information.

In some implementations, the method of FIG. 5 further includes a step S520 in which the terminal device receives the second information transmitted by the network device. The second information is associated with the second positioning mode. For example, the second information is used to enable the second positioning mode. After the second positioning mode is enabled, the terminal device may obtain accurate location information based on the second positioning mode. The second positioning mode may be, for example, a positioning mode based on positioning reference signal resources.

In some implementations, the association of the second information with the second positioning mode may include or be replaced by that: the second information is used to activate the positioning reference signal resources. It should be understood that the positioning reference signal referred to herein may be any type of reference signal capable of serving as a positioning function. For example, it may be a positioning reference signal (PRS) or a sounding reference signal (SRS) that can be used for positioning. In some implementations, the network device may pre-configure one or more positioning reference signal resources for the terminal device, and the one or more positioning reference signal resources are in an inactive state by default. The one or more positioning reference signal resources are activated after the terminal device receives the second information from the network device.

The embodiment of the present disclosure does not specifically limit the mode of carrying the second information. For example, the second information may be carried by downlink control information (DCI) or may be carried by MAC CE. Two possible implementations are given below.

The first implementation: the second information is carried by first DCI (or first DCI format)

If the second information is used to activate the positioning reference signal resources, the second information is carried in the first DCI, representing that the activation of the positioning reference signal resources is triggered by the first DCI.

The embodiment of the present disclosure does not specifically limit the type of the first DCI. For example, the first DCI may include a DCI for scheduling a PUSCH and/or a PDSCH. Exemplarily, the DCI format of the first DCI is DCI format 1_0, DCI format 1_1, DCI format 0_0, or DCI format 0_1. The aforementioned DCI format may use a cell radio network temporary identifier (C-RNTI) for cyclic redundancy check (CRC) scrambling. As another example, the first DCI may include a DCI not used to schedule the PUSCH and/or the PDSCH. As another example, the first DCI may include group-common DCI.

In some implementations, the first DCI may be used to activate: positioning reference signal resources corresponding to one or more cells; and/or positioning reference signal resources corresponding to the one or more TRPs.

For example, the first DCI may include activation information of the first cell (belonging to the aforementioned second information). The activation information is located at a first location in the first DCI, and the first location is pre-configured by the network device for the terminal device.

As another example, the first DCI may include activation information of the first TRP (belonging to the second information mentioned above). The activation information is located at a first location in the first DCI, and the first location is pre-configured by the network device for the terminal device.

In some implementations, the first DCI includes one or more indication fields. The one or more indication fields are used to activate the positioning reference signal resources. For example, the first DCI includes an indication field for activating the positioning reference signal resources. The indication domain may be a newly added indication domain (relative to legacy DCI). Alternatively, the indication field may reuse an existing indication field in the DCI. As another example, the first DCI may include multiple indication fields. A set of values of multiple indication domains may be pre-defined or configured based on the network device. Once the set of values of the multiple indication fields satisfies a condition, the terminal device determines that the multiple indication fields are used to indicate activation of the positioning reference signal resources.

In some implementations, the first DCI is transmitted on DCI monitoring occasions (MOs) configured by the network device. The monitoring occasions may be determined based on configuration information of the network device. Since the network device may not be aware in advance whether the first location information of the terminal device is valid, the network device does not actively activate the positioning reference signal resources configured for the terminal device. Therefore, the terminal device does not need to monitor the DCI on the monitoring occasions before transmitting the first information to the network device. After the terminal device transmits the first information to the network device, the terminal device may start to perform DCI monitoring on the monitoring occasions. Accordingly, the network device may transmit the first DCI on the monitoring occasions after receiving the first information transmitted by the terminal device.

The second implementation: the second information is carried by the first MAC CE

If the second information is used to activate the positioning reference signal resources, the second information is carried in the first MAC CE, representing that activation of the positioning reference signal resources is triggered by the first MAC CE.

In some implementations, an effective time of the second information (or an activation time of the positioning reference signal resources) may be determined based on a transmission time and/or a first delay of feedback information (such as acknowledgement (ACK) information) corresponding to the first MAC CE. For example, the effective time of the second information may be set as the transmission time of the feedback information plus the first delay. The first delay mentioned herein may be determined based on pre-defined information or by configuration information of the network device.

In some implementations, the first MAC CE is used to activate one or more of: positioning reference signal resources corresponding to one or more cells; positioning reference signal resources corresponding to one or more transmission reception points (TRPs); or positioning reference signal resources corresponding to one or more bandwidth parts (BWPs).

For example, the first MAC CE may include identifications of one or more cells and their corresponding activation domains (for storing activation information of the positioning reference signal resources).

As another example, the first MAC CE may include identifiers of one or more BWPs and their corresponding activation fields (for storing activation information of the positioning reference signal resources).

As another example, the first MAC CE may include identifications of one or more TRPs and their corresponding activation fields (for storing activation information of the positioning reference signal resources).

In some implementations, the terminal device expects to receive the second information before end of a second period of time. Alternatively, the terminal device does not expect to receive the second information after end of the second period of time.

The above-mentioned second period of time may be the same period as the above-mentioned first period of time, or may be different from the first period of time. In some implementations, the start time of the second period of time is associated with a transmission time of the first information. For example, the start time of the second period of time is the same as the transmission time of the first information. The duration of the second period of time may be determined based on protocol predefined information and configuration information of the network device. Alternatively, the duration of the second period of time may be reported by the terminal device.

In some implementations, the second information is carried on the first MAC CE, and the transmission time of the feedback information corresponding to the first MAC CE should be earlier than the end time of the second period of time.

In some implementations, after the end of the first period of time, the terminal device enters an idle state. The terminal device entering the idle state can save power consumption.

In some implementations, if the second information is not received, the terminal device enters an idle state. The terminal device enters the idle state, which can save power consumption.

In some implementations, the terminal device sends the third information to the network device. The third information is used to inform the network device that the terminal device intends to enter the idle state. The third information may be carried in a physical random access channel (PRACH).

In some implementations, if the second information is not received, the terminal device sends the third information to the network device. The third information is used to inform the network device that the terminal device intends to enter the idle state. The third information may be carried in the PRACH.

In some implementations, after the end of the first period of time, if the time alignment timer (TAT) is still running, the terminal device continues the uplink transmissions. This is because, during TAT, the network device is still able to correct the time error by means of timing advance (TA) adjustment.

In some implementations, if the second information is not received and the TAT is still running, the terminal device continues the uplink transmissions.

In some implementations, after the end of the first period of time, if the location information of the terminal device is still in an invalid state, the terminal device performs downlink transmissions instead of uplink transmissions.

Alternatively, in some implementations, the first information refers to information transmitted when the first location information is invalid, about to be invalid, or deteriorated, and the first information is used to request the second positioning mode.

FIG. 6 is a schematic flow diagram of a method for positioning according to another embodiment of the present disclosure. The method of FIG. 6 is described from the perspective of interaction between the terminal device and the network device. The terminal device may be a terminal device in an NTN NR communication system. Alternatively, the terminal device may be a terminal device in an NTN IOT system. Alternatively, the terminal device may be any type of terminal device capable of supporting the method for positioning provided by the embodiment of the present disclosure.

Referring to FIG. 6, in operation S610, the terminal device receives the second information transmitted by the network device. The second information is associated with a second positioning mode, and the second positioning mode is used for positioning the terminal device when the first location information (the related description of the first location information may be refer to the embodiment corresponding to FIG. 5) is invalid.

For example, the second information is used to enable the second positioning mode. After the second positioning mode is enabled, the terminal device may obtain accurate location information based on the second positioning mode. The second positioning mode may be, for example, a positioning mode based on the positioning reference signal resources.

In some implementations, the association of the second information with the second positioning mode may include or be replaced by that: the second information is used to activate the positioning reference signal resources. It should be understood that the positioning reference signal mentioned herein may be any type of reference signal capable of positioning, such as PRS or SRS. For example, the network device may pre-configure one or more positioning reference signal resources for the terminal device, and the one or more positioning reference signal resources are in an inactive state by default. The one or more positioning reference signal resources are activated after the terminal device receives the second information from the network device.

The embodiment of the present disclosure does not specifically limit the mode of carrying the second information. For example, the second information may be carried by DCI or MAC CE. Two possible implementations are given below.

The first implementation: the second information is carried by first DCI (or first DCI format)

If the second information is used to activate the positioning reference signal resources, the second information is carried in the first DCI, representing that the activation of the positioning reference signal resources is triggered by the first DCI.

The embodiment of the present disclosure does not specifically limit the type of the first DCI. For example, the first DCI may include a DCI for scheduling a PUSCH and/or a PDSCH. Exemplarily, the DCI format of the first DCI is DCI format 1_0, DCI format 1_1, DCI format 0_0, or DCI format 0_1. The above-described DCI format may use C-RNTI for CRC scrambling. As another example, the first DCI may include a DCI not used to schedule the PUSCH and/or the PDSCH. As another example, the first DCI may include group-common DCI.

In some implementations, the first DCI may be used to activate: positioning reference signal resources corresponding to one or more cells; and/or positioning reference signal resources corresponding to the one or more TRPs.

For example, the first DCI may include activation information of the first cell (belonging to the aforementioned second information). The activation information is located at a first location in the first DCI, and the first location is pre-configured by the network device for the terminal device.

As another example, the first DCI may include activation information of the first TRP (belonging to the second information mentioned above). The activation information is located at a first location in the first DCI, and the first location is pre-configured by the network device for the terminal device.

In some implementations, the first DCI includes one or more indication fields. The one or more indication fields are used to activate the positioning reference signal sources. For example, the first DCI includes an indication field for activating the positioning reference signal sources. The indication domain may be a newly added indication domain (relative to legacy DCI). Alternatively, the indication field may reuse an existing indication field in the DCI. As another example, the first DCI may include multiple indication fields. A set of values of multiple indication domains may be pre-defined or configured based on the network device. Once the combination of values of the multiple indication fields satisfies the condition, the terminal device determines that the multiple indication fields are used to indicate activation of the positioning reference signal sources.

In some implementations, the first DCI is transmitted in the MO of the DCI configured by the network device. The monitoring occasions may be determined based on configuration information of the network device. Since the network device cannot obtain prior information about whether the first location information of the terminal device is valid or not, the network device will not actively activate the positioning reference signal sources configured for the terminal device. Therefore, the terminal device does not need to monitor DCI on the monitoring occasions before transmitting the first information to the network device, but only needs to start to monitor DCI on the monitoring occasions after the terminal device transmits the first information to the network device. Accordingly, the network device may transmit the first DCI on the monitoring occasions after receiving the first information transmitted by the terminal device.

The second implementation: the second information is carried by the first MAC CE

If the second information is used to activate the positioning reference signal resources, the second information is carried in the first MAC CE, representing that activation of the positioning reference signal resources is triggered by the first MAC CE.

The effective time of the second information (or the activation time of the positioning reference signal resources) is determined based on the transmission time and/or a first delay of feedback information (such as ACK information) corresponding to the first MAC CE. For example, the effective time of the second information may be set as the transmission time of the feedback information plus the first delay. The first delay mentioned herein may be determined based on pre-defined information or by configuration information of the network device.

In some implementations, the first MAC CE is used to activate one or more of: positioning reference signal resources corresponding to one or more cells; positioning reference signal resources corresponding to one or more TRPs; or positioning reference signal resources corresponding to one or more BWPs.

For example, the first MAC CE may include identifications of one or more cells and their corresponding activation domains (for storing activation information of the positioning reference signal sources).

As another example, the first MAC CE may include identifications of one or more BWPs and their corresponding activation fields (for storing activation information of the positioning reference signal sources).

As another example, the first MAC CE may include identifiers of one or more TRPs and their corresponding activation fields (for storing activation information of the positioning reference signal sources).

In some implementations, the terminal device expects to receive the second information before end of a second period of time. Alternatively, the terminal device does not expect to receive the second information after end of the second period of time.

The above-mentioned second period of time may be the same period as the above-mentioned first period of time, or may be different from the first period of time. In some implementations, the start time of the second period of time is associated with a transmission time of the first information. For example, the start time of the second period of time is the same as the transmission time of the first information. The duration of the second period of time may be determined based on protocol pre-defined information and configuration information of the network device. Alternatively, the duration of the second period of time may be reported by the terminal device.

In some implementations, the second information is carried on the first MAC CE, and the transmission time of the feedback information corresponding to the first MAC CE is earlier than the end time of the second period of time.

In some implementations, after the end of the first period of time, the terminal device enters an idle state. The terminal device entering the idle state can save power consumption.

In some implementations, if the second information is not received, the terminal device enters an idle state. The terminal device entering the idle state can save power consumption.

In some implementations, the terminal device sends the third information to the network device. The third information is used to inform the network device that the terminal device intends to enter the idle state. The third information may be carried in the PRACH.

In some implementations, if the second information is not received, the terminal device sends the third information to the network device. The third information is used to inform the network device that the terminal device intends to enter the idle state. The third information may be carried in the PRACH.

In some implementations, after the end of the first period of time, if the time alignment timer (TAT) is still running, the terminal device continues the uplink transmissions. This is because, during TAT, the network device can still correct the time error by means of TA adjustment.

In some implementations, if the second information is not received and the TAT is still running, the terminal device continues the uplink transmissions.

In some implementations, after the end of the first period of time, if the location information of the terminal device is still in an invalid state, the terminal device performs downlink transmissions, but not performing uplink transmissions.

It should be noted that the embodiments of FIG. 5 or FIG. 6 may include a capability reporting process of the terminal device. For example, the terminal device transmits capability information to the network device, and the capability information is used to indicate that the terminal device supports a positioning mode based on a positioning reference signal. The positioning reference signal may be transmitted by the base station or by a network element in the core network (e.g., a location management function (LMF)).

Embodiments of the method of the present disclosure are described in detail above with reference to FIGS. 1 to 6, and embodiments of the device of the present disclosure are described in detail below with reference to FIGS. 7 to 11. It should be understood that the description of the method embodiment correspond to the description of the device embodiment, and therefore, the portions not described in detail may be referred to the foregoing method embodiments.

FIG. 7 is a schematic structural diagram of a terminal device according to an embodiment of the present disclosure. The terminal device 700 illustrated in FIG. 7 may include a communication module 710. The communication module 710 is configured to transmit first information to the network device, the first information is associated with validity of the first location information, the first location information is determined based on a first positioning mode, and the first positioning mode is a satellite-based positioning mode.

In some implementations, the first information is used to indicate one or more of: a first period of time, the first period of time is a valid period of time of the first location information; the first location information is invalid or intends to be invalid; or accuracy of the first location information does not satisfy a condition.

In some implementations, the communication module 710 is further configured to receive second information transmitted by the network device, and the second information is associated with a second positioning mode, and the second positioning mode is configured to position the terminal device when the first positioning information is invalid.

In some implementations, the second information is used to: enable the second positioning mode, or activate the positioning reference signal resources.

In some implementations, the second information is carried in first DCI.

In some implementations, the first DCI includes one or more of: a DCI for scheduling a PUSCH and/or a PDSCH, DCI not used to schedule PUSCH and PDSCH, or group-common DCI.

In some implementations, the first DCI is used to activate one or more of: positioning reference signal resources corresponding to one or more cells; or positioning reference signal resources corresponding to one or more TRPs.

In some implementations, the first DCI is transmitted on DCI monitoring occasions configured by the network device, and the communication module 710 is further configured to start to perform DCI monitoring on the monitoring occasions after the terminal device transmits the first information to the network device.

In some implementations, the second information is carried in a first MAC CE.

In some implementations, the effective time of the second information is determined based on a transmission time and/or a first delay of feedback information corresponding to the first MAC CE.

In some implementations, the first MAC CE is used to activate one or more of: positioning reference signal resources corresponding to one or more cells; positioning reference signal resources corresponding to one or more TRPs; or positioning reference signal resources corresponding to one or more BWPs.

In some implementations, the first MAC CE includes one or more of: identifications of one or more cells; identifications of one or more TRPs; identifications of one or more BWPs; or activation information of the positioning reference signal resources.

In some implementations, the terminal device expects to receive the second information before end of a second period of time. Alternatively, the terminal device does not expect to receive the second information after end of a second period of time. The second period of time is the same period of time as the first period of time. Alternatively, the start time of the second period of time is associated with a transmission time of the first information.

In some implementations, the second information is carried on a first MAC CE, and a transmission time of feedback information corresponding to the first MAC CE is earlier than an end time of the second period of time.

In some implementations, the terminal device 700 further includes: a processing module, if the second information is not received, the processing module is configured to perform one or more of the following: entering an idle state; transmitting third information to the network device, the third information being used to notify the network device that the terminal device intends to enter an idle state; continuing the uplink transmissions during the time alignment timer TAT is running; or after end of the first period of time, performing downlink transmissions, but not performing uplink transmissions.

In some implementations, the third information is carried in a PRACH.

In some implementations, the satellite is a positioning navigation satellite.

In some implementations, the positioning navigation satellite includes one or more of: GPS satellites; GNSS satellites; Galileo satellites; or Beidou satellites.

In an embodiment of the present disclosure, the terminal device transmits the first information to the network device. The first information is associated with the validity of the first location information determined by satellite-based positioning mode. The transmission of the first information helps the network device to understand the validity of the first location information, so as to better schedule the terminal device.

is a schematic structural diagram of a terminal device according to another embodiment of the present disclosure. The terminal device 800 illustrated in FIG. 8 may include a communication module 810. The communication module 810 is configured to receive second information transmitted by the network device, and the second information is associated with a second positioning mode, the second positioning mode is configured to position the terminal device when first location information is invalid, the first location information is determined based on the first positioning mode, and the first positioning mode is a satellite-based positioning mode.

In some implementations, the second information is used to: enable the second positioning mode; or activating the positioning reference signal resources.

In some implementations, the second information is carried in first DCI.

In some implementations, the first DCI includes one or more of: DCI for scheduling a PUSCH and/or a PDSCH; DCI not used to schedule PUSCH and PDSCH; or group-common DCI.

In some implementations, the first DCI is used to activate one or more of: positioning reference signal resources corresponding to one or more cells; or positioning reference signal resources corresponding to one or more TRPs.

In some implementations, the first DCI is transmitted on DCI monitoring occasions configured by the network device, and the communication module 810 is further configured to: start to performing DCI monitoring on the monitoring occasions after the terminal device transmits first information to the network device, the first information is used to indicate one or more of: a first period of time, the first period of time is a valid period of time of the first location information; the first location information is invalid or intends to be invalid; or accuracy of the first location information does not satisfy a condition.

In some implementations, the second information is carried in a first MAC CE.

In some implementations, the effective time of the second information is determined based on a transmission time and/or a first delay of feedback information corresponding to the first MAC CE.

In some implementations, the first MAC CE is used to activate one or more of: positioning reference signal resources corresponding to one or more cells; positioning reference signal resources corresponding to one or more TRPs; or positioning reference signal resources corresponding to one or more BWPs.

In some implementations, the first MAC CE includes one or more of: identifications of one or more cells; identifications of one or more TRPs; identifications of one or more BWPs; or activation information of the positioning reference signal resources.

In some implementations, the terminal device expects to receive the second information before end of a second period of time; or, the terminal device does not expect to receive the second information after the end of a second period of time. The second period of time is the same period of time as the first period of time; or, a start time of the second period of time is associated with a transmission time of first information, the first information is used to indicate the first period of time, and the first period of time is a valid period of time of the first location information.

In some implementations, the second information is carried on a first MAC CE, and a transmission time of feedback information corresponding to the first MAC CE is earlier than an end time of the second period of time.

In some implementations, the terminal device 800 further includes: a processing module, if the second information is not received, the processing module is configured to perform one or more of the following: entering an idle state; transmitting third information to the network device, the third information being used to notify the network device that the terminal device intends to enter an idle state; continuing uplink transmissions during the time alignment timer (TAT) is running; or performing downlink transmissions without performing uplink transmissions after end of a first period of time. The first period of time is a valid period of time of the first location information.

In some implementations, the third information is carried in a PRACH.

In some implementations, the satellite is a positioning navigation satellite.

In some implementations, the positioning navigation satellite includes one or more of: GPS satellites; GNSS satellites; Galileo satellites; or Beidou satellites.

FIG. 9 is a schematic structural diagram of a network device according to an embodiment of the present disclosure. The network device 900 illustrated in FIG. 9 may include a communication module 910. The communication module 910 is configured to receive first information transmitted by a terminal device, the first information is associated with validity of first location information, the first location information is determined based on a first positioning mode, and the first positioning mode is a satellite-based positioning mode.

In some implementations, the first information is used to indicate one or more of: a first period of time, the first period of time is a valid period of time of the first location information; the first location information is invalid or intends to be invalid; or accuracy of the first location information does not satisfy a condition.

In some implementations, the communication module 910 is further configured to send second information to the terminal device, the second information is associated with a second positioning mode, and the second positioning mode is configured to position the terminal device when the first location information is invalid.

In some implementations, the second information is used to enable the second positioning mode, or activate positioning reference signal resources.

In some implementations, the second information is carried in first DCI.

In some implementations, the first DCI includes one or more of: DCI for scheduling a PUSCH and/or a PDSCH; DCI not used to schedule PUSCH and PDSCH; or group-common DCI.

In some implementations, the first DCI is used to activate one or more of: positioning reference signal resources corresponding to one or more cells; or positioning reference signal resources corresponding to one or more transmission reception points (TRPs).

In some implementations, the first DCI is transmitted on DCI monitoring occasions configured by the network device, and the communication module 910 is further configured to transmit the first DCI on the monitoring occasions after the network device receives the first information transmitted by the terminal device.

In some implementations, the second information is carried in a first MAC CE.

In some implementations, the effective time of the second information is determined based on a transmission time and/or a first delay of feedback information corresponding to the first MAC CE.

In some implementations, the first MAC CE is used to activate one or more of: positioning reference signal resources corresponding to one or more cells; positioning reference signal resources corresponding to one or more TRPs; or positioning reference signal resources corresponding to the one or more bandwidth parts (BWPs).

In some implementations, the first MAC CE includes one or more of: identifications of one or more cells; identifications of one or more TRPs; identifications of one or more BWPs; or activation information of the positioning reference signal resources.

In some implementations, the communication module 910 is further configured to: transmit the second information before end of a second period of time. The second period of time is the same period of time as a first period of time; or, a start time of the second period of time is associated with a transmission time of the first information.

In some implementations, the second information is carried on a first MAC CE, and a transmission time of feedback information corresponding to the first MAC CE is earlier than an end time of the second period of time.

In some implementations, the communication module 910 is further configured to receive third information transmitted by the terminal device, and the third information is configured to notify the network device that the terminal device intends to enter an idle state.

In some implementations, the third information is carried in a PRACH.

In some implementations, the satellite is a positioning navigation satellite.

In some implementations, the positioning navigation satellite includes one or more of: GPS satellites; GNSS satellites; Galileo satellites; or Beidou satellites.

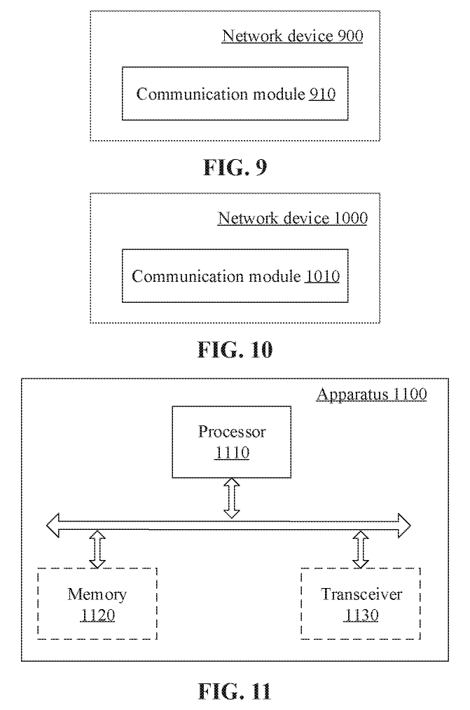

FIG. 10 is a schematic structural diagram of a network device according to an embodiment of the present disclosure. The network device 1000 illustrated in FIG. 10 may include a communication module 1010. The communication module 1010 is configured to transmit second information to a terminal device, the second information is associated with a second positioning mode, the second positioning mode is configured to position the terminal device when first location information is invalid, the first location information is determined based on the first positioning mode, and the first positioning mode is a satellite-based positioning mode.

In some implementations, the second information is used to enable the second positioning mode, or activate positioning reference signal resources.

In some implementations, the second information is carried in first DCI.

In some implementations, the first DCI includes one or more of: DCI for scheduling a PUSCH and/or a PDSCH; DCI not used to schedule PUSCH and PDSCH; or group-common DCI.

In some implementations, the first DCI is used to activate one or more of: positioning reference signal resources corresponding to one or more cells; or positioning reference signal resources corresponding to one or more TRPs.

In some implementations, the first DCI is transmitted on DCI monitoring occasions configured by the network device, and the communication module 1010 is further configured to transmit the first DCI on the monitoring occasions after the network device receives first information transmitted by the terminal device. The first information is used to indicate one or more of: a first period of time, the first period of time being a valid period of time of the first location information; the first location information is invalid or intends to be invalid; or accuracy of the first location information does not satisfy a condition.

In some implementations, the second information is carried in a first MAC CE.

In some implementations, an effective time of the second information is determined based on a transmission time and/or a first delay of feedback information corresponding to the first MAC CE.

In some implementations, the first MAC CE is used to activate one or more of: positioning reference signal resources corresponding to one or more cells; positioning reference signal resources corresponding to one or more TRPs; or positioning reference signal resources corresponding to one or more BWPs.

In some implementations, the first MAC CE includes one or more of: identifications of one or more cells; identifications of one or more TRPs; identifications of one or more BWPs; or activation information of the positioning reference signal resources.

In some implementations, the communication module 1010 is further configured to transmit the second information to the terminal device after end of a second period of time. The second period of time is the same period of time as a first period of time. Alternatively, a start time of the second period of time is associated with a transmission time of first information, the first information is used to indicate the first period of time, and the first period of time is a valid period of time of the first location information.

In some implementations, the second information is carried on a first MAC CE, and a transmission time of feedback information corresponding to the first MAC CE is earlier than an end time of the second period of time.

In some implementations, the communication module 1010 is further configured to receive third information transmitted by the terminal device, and the third information is configured to notify the network device that the terminal device intends to enter an idle state.

In some implementations, the third information is carried in a PRACH.

In some implementations, the satellite is a positioning navigation satellite.

In some implementations, the positioning navigation satellite includes one or more of: GPS satellites; GNSS satellites; Galileo satellites; or Beidou satellites.

FIG. 11 is a schematic structural diagram of an apparatus according to an embodiment of the present disclosure. The dashed line in FIG. 11 indicates that the unit or module is optional. The apparatus 1100 may be used to implement the method described in the method embodiments described above. The apparatus 1100 may be a chip, a terminal device, or a network device.

The apparatus 1100 may include one or more processors 1110. The processor 1110 may support the apparatus 1100 to implement the methods described in the above method embodiments. The processor 1110 may be a general-purpose processor or a special-purpose processor. For example, the processor may be a central processing unit (CPU). Alternatively, the processor may also be another general purpose processor, a digital signal processor (DSP), an application specific integrated circuit (ASIC), a field programmable gate array (FPGA) or other programmable logic device, a discrete gate or transistor logic device, a discrete hardware component, or the like. The general purpose processor may be a microprocessor or the processor may be any conventional processor or the like.

The apparatus 1100 may also include one or more memories 1120. A program stored on the memory 1120, which can be executed by the processor 1110, causes the apparatus 1100 to perform the method described in the above method embodiments. The memory 1120 may be independent of the processor 1110 or may be integrated in the processor 1110.

The apparatus 1100 may also include a transceiver 1130. The processor 1110 may communicate with other devices or chips through the transceiver 1130. For example, the processor 1110 may transmit and receive data with other devices or chips through the transceiver 1130.

An embodiment of the present disclosure further provides a computer-readable storage medium for storing a program. The computer-readable storage medium can be applied to a terminal device or a network device provided by an embodiment of the present disclosure, and the program causes a computer to execute a method executed by the terminal device or the network device in each embodiment of the present disclosure.

Embodiments of the present disclosure also provide a computer program product. The computer program product includes a program. The computer program product may be applied to a terminal device or a network device provided by an embodiment of the present disclosure, and the program causes a computer to execute a method executed by the terminal device or the network device in each embodiment of the present disclosure.

Embodiments of the present disclosure also provide a computer program. The computer program can be applied to a terminal device or a network device provided by an embodiment of the present disclosure, and the computer program causes a computer to execute a method executed by the terminal device or the network device in each embodiment of the present disclosure.

It should be understood that in embodiments of the present disclosure, "B corresponding to A" means that B is associated with A, and B may be determined from A. However, it should also be understood that determining B from A does not mean that B is determined from A alone, and that B may also be determined from A and/or other information.

It should be understood that the term "and/or" herein is merely an association relationship describing an association object, and means that there may be three relationships, for example, A and/or B, which may mean: A alone, A and B at the same time, and B alone. In addition, the character "/" herein generally indicates that the related objects before and after are in an "or" relationship.

It should be understood that in various embodiments of the present disclosure, the sequence numbers of the above-described processes do not mean the sequence of execution, and the sequence of execution of each process should be determined by its function and internal logic, and should not constitute any limitation on the implementation of the embodiments of the present disclosure.

In several embodiments provided in the present disclosure, it should be understood that the disclosed systems, apparatuses, and methods may be implemented in other ways. For example, the device embodiments described above are merely schematic, for example, the division of units is only one logical function division, and there may be other division methods in actual implementation. For example, multiple units or components may be combined or integrated into another system, or some features may be ignored or not implemented. In addition, the coupling or direct coupling or communication connection between each other illustrated or discussed may be an indirect coupling or communication connection through some interfaces, devices or units, which may be electrical, mechanical or otherwise.

The units described as separate units may or may not be physically separate, and the components displayed as units may or may not be physical units, that is, they may be located in one place or may be distributed over multiple network units. Some or all of the units may be selected according to actual needs to achieve the purpose of the solution of the present embodiment.

In addition, each functional unit in each embodiment of the present disclosure may be integrated in one processing unit, each unit may be physically present alone, or two or more units may be integrated in one unit.

In the embodiments described above, it may be implemented in whole or in part by software, hardware, firmware, or any combination thereof. When implemented using software, it may be implemented in whole or in part in the form of a computer program product. The computer program product includes one or more computer instructions. When the computer program instructions are loaded and executed on a computer, the processes or functions described in accordance with embodiments of the present disclosure are generated in whole or in part. The computer may be a general purpose computer, a special purpose computer, a computer network, or other programmable device. The computer instructions may be stored in a computer-readable storage medium or transmitted from a computer-readable storage medium to another computer-readable storage medium. For example, the computer instructions may be transmitted from one website site, computer, server, or data center by wired (e.g., coaxial cable, optical fiber, digital subscriber line (DSL)) or wireless (e.g., infrared, wireless, microwave, etc.) means to another website site, computer, server, or data center. The computer-readable storage medium may be any available medium that can be read by a computer or a data storage device such as a server that incorporates one or more available media integrations, a data center, or the like. The available media may be magnetic media (e.g., floppy disk, hard disk, magnetic tape), optical media (e.g., digital video disc (DVD)), or semiconductor media (e.g., solid state disk (SSD)), etc.

The above descriptions are merely specific implementations of the present disclosure, but the scope of protection of the present disclosure is not limited thereto. Variations or replacements can be readily conceived by those skilled in the art within the technical scope disclosed by the disclosure, and shall fall within the scope of protection of the disclosure. Therefore, the scope of protection of the application shall be subject to the scope of protection of the claim.

1. A method for positioning, comprising:
transmitting, by a terminal device, first information to a network device, the first information being associated with validity of first location information, the first location information being determined based on a first positioning mode, and the first positioning mode being a satellite-based positioning mode.

2. The method of claim 1, wherein the first information is used to indicate one or more of:
a first period of time, the first period of time being a valid period of time of the first location information;
the first location information is invalid or intends to be invalid; or
accuracy of the first location information does not satisfy a condition.

3. The method of claim 2, further comprising:
receiving, by the terminal device, second information transmitted by the network device, the second information being associated with a second positioning mode, the second positioning mode being used to position the terminal device when the first location information is invalid,
wherein the second information is used to:
enable the second positioning mode; or
activate positioning reference signal resources.

4. The method of claim 3, wherein the second information is carried in first downlink control information (DCI),
wherein the first DCI comprises one or more of:
DCI for scheduling at least one of a physical uplink shared channel (PUSCH) or a physical downlink shared channel (PDSCH);
DCI not used to schedule PUSCH and PDSCH; or
group-common DCI, and
wherein the first DCI is used to activate one or more of:
positioning reference signal resources corresponding to one or more cells; or
positioning reference signal resources corresponding to one or more transmission reception points (TRPs).

5. The method of claim 4, wherein the first DCI is transmitted on DCI monitoring occasions configured by the network device, and
the method further comprises:
starting, by the terminal device, to perform DCI monitoring on the monitoring occasions, after the terminal device sends the first information to the network device.

6. The method of claim 3, wherein the second information is carried in a first media access control control element (MAC CE), and
wherein an effective time of the second information is determined based on at least one of a transmission time or a first delay of feedback information corresponding to the first MAC CE.

7. The method of claim 6, wherein the first MAC CE is used to activate one or more of:
positioning reference signal resources corresponding to one or more cells;
positioning reference signal resources corresponding to one or more TRPs; or
positioning reference signal resources corresponding to one or more bandwidth parts (BWPs), and
wherein the first MAC CE comprises one or more of:
identifications of one or more cells;
identifications of one or more TRPs;
identifications of one or more BWPs; or
activation information of the positioning reference signal resources.

8. The method of claim 3, wherein
the terminal device expects to receive the second information before end of a second period of time; or
the terminal device does not expect to receive the second information after end of a second period of time;
wherein the second period of time is the same period of time as a first period of time; or, a start time of the second period of time is associated with a transmission time of the first information, and
wherein the second information is carried on a first MAC CE, and a transmission time of feedback information corresponding to the first MAC CE is earlier than an end time of the second period of time.

9. The method of claim 3, further comprising:
if the second information is not received, performing, by the terminal device, one or more of the following:
entering an idle state;
transmitting third information to the network device, the third information being used to notify the network device that the terminal device intends to enter an idle state;
continuing uplink transmissions during a time alignment timer (TAT) is running; or
after end of a first period of time, performing downlink transmissions, but not performing uplink transmissions,
wherein the third information is carried in a physical random access channel (PRACH).

10. The method of claim 1, wherein the satellite is a positioning navigation satellite, and
wherein the positioning navigation satellite comprises one or more of:
global positioning system (GPS) satellites;
global navigation satellite system (GNSS) satellites;
Galileo satellites; or
Beidou satellites.

11. A terminal device, comprising a memory for storing a program and a processor for invoking the program in the memory to cause the terminal device to:
send first information to a network device, the first information being associated with validity of first location information, the first location information being determined based on a first positioning mode, and the first positioning mode being a satellite-based positioning mode.

12. The terminal device of claim 11, wherein the processor invokes the program in the memory to further cause the terminal device to:
receive second information transmitted by the network device, the second information being associated with a second positioning mode, and the second positioning mode being used to position the terminal device when the first location information is invalid, and
wherein the second information is used to:
enable the second positioning mode; or
activate positioning reference signal resources.

13. The terminal device of claim 12, wherein the second information is carried in first downlink control information (DCI), and
wherein the first DCI includes one or more of:
DCI for scheduling at least one of a physical uplink shared channel (PUSCH) or a physical downlink shared channel (PDSCH);
DCI not used to schedule PUSCH and PDSCH; or
group-common DCI.

14. The terminal device of claim 13, wherein the first DCI is used to activate one or more of:
positioning reference signal resources corresponding to one or more cells; or
positioning reference signal resources corresponding to one or more transmission reception points (TRPs), and
wherein the first DCI is transmitted on DCI monitoring occasions configured by the network device, and
the processor invokes the program in the memory to further cause the terminal device to:
after the terminal device transmits the first information to the network device, start to perform DCI monitoring on the monitoring occasions.

15. A network device, comprising a memory for storing a program and a processor for invoking the program in the memory to cause the network device to:
receive first information transmitted by a terminal device, the first information being associated with validity of first location information, the first location information being determined based on a first positioning mode, and the first positioning mode being a satellite-based positioning mode.

16. The network device of claim 15, wherein the processor invokes the program in the memory to further cause the network device to:
transmit second information to the terminal device, the second information being associated with a second positioning mode, and the second positioning mode being configured to position the terminal device when the first location information is invalid, and
wherein the second information is used to:
enable the second positioning mode; or
activate positioning reference signal resources.

17. The network device of claim 16, wherein the second information is carried in a first media access control control element (MAC CE), and
wherein an effective time of the second information is determined based on at least one of a transmission time or a first delay of feedback information corresponding to the first MAC CE.

18. The network device of claim 17, wherein the first MAC CE is used to activate one or more of:
positioning reference signal resources corresponding to one or more cells;
positioning reference signal resources corresponding to one or more TRPs; or
positioning reference signal resources corresponding to the one or more bandwidth parts (BWPs), and
wherein the first MAC CE comprises one or more of:
identifications of one or more cells;
identifications of one or more TRPs;
identifications of one or more BWPs; or
activation information of the positioning reference signal resources.

19. The network device of claim 15, wherein the processor invokes the program in the memory to further cause the network device to:
transmit the second information before the end of a second period of time;
wherein the second period of time is the same period of time as the first period of time; or, a start time of the second period of time is associated with a transmission time of the first information, and
wherein the second information is carried on a first MAC CE, and a transmission time of feedback information corresponding to the first MAC CE is earlier than an end time of the second period of time.

20. The network device of claim 15, wherein the processor invokes the program in the memory to further cause the network device to:
receive third information transmitted by the terminal device, wherein the third information is used to notify the network device that the terminal device intends to enter an idle state, and
wherein the third information is carried in a physical random access channel (PRACH).
